(19) United States
(12) Patent Application Publication
(10) Pub. No.: US 2017/0023729 A1
(43) Pub. Date: Jan. 26, 2017

(54) MANUFACTURING METHOD OF LIGHT GUIDE PLATE

(71) Applicant: Young Lighting Technology Inc., Hsin-Chu (TW)

(72) Inventors: Hao-Jan Kuo, Hsin-Chu (TW); Shih-Wei Liu, Hsin-Chu (TW)

(21) Appl. No.: 15/132,251

(22) Filed: Apr. 19, 2016

(30) Foreign Application Priority Data
Jul. 22, 2015 (TW) 104123642

(51) Int. Cl. F21V 8/00; B23K 26/362; B29C 59/04; B29D 11/00; B29C 45/00; B29C 69/00

(52) U.S. Cl. CPC G02B 6/0065; G02B 6/0043; B29C 45/0055; B29C 69/001; B29C 59/04; B29D 11/00721; B23K 26/362; B29K 2995/0026; B29K 2105/256

(57) ABSTRACT

A manufacturing method of a light guide plate. A transparent plate is provided, wherein a surface of the transparent plate has a plurality of first optical microstructures. Then, a first hot pressing roller having a plurality of transfer printing microstructures is provided. A plurality of second optical microstructures are formed on the surface through the transfer printing microstructures by the first hot pressing roller. At least a part of the second optical microstructures is not overlapped with the first optical microstructures.

### CROSS-REFERENCE TO RELATED APPLICATION

This application claims the priority benefit of Taiwan application serial no. 104123642, filed on Jul. 22, 2015. The entirety of the above-mentioned patent application is hereby incorporated by reference herein and made a part of this specification.

### BACKGROUND OF THE INVENTION

1. Field of the Invention

The invention relates to a manufacturing method of a light guide plate applied in a backlight module. More particularly, the invention relates to a manufacturing method of a light guide plate and optical microstructures thereof.

2. Description of Related Art

Currently, many electronic devices utilize flat panel display modules to display images. In particular, the technology of liquid crystal display (LCD) modules is more mature and popular. However, the display panels of LCD modules are not capable of emitting light, and therefore backlight modules disposed under the LCD panels are required for providing light sources and achieving display functions. Backlight modules are mainly categorized to be a side type backlight module or a direct type backlight module. Backlight modules utilize light guide plates so that light emitted from the light source disposed at a light incident surface of the light guide plate is directed to a light exit surface. This way, a planar light source is formed.

Generally, optical microstructures are formed on the surface of the light guide plate for enhancing the brightness and light emitting uniformity of the light guide plate. A common process of forming the optical microstructures of the light guide plate is through an injection molding process. The advantage is that the transfer ratio of the optical structures is high and stable, and therefore is suitable for optical microstructures with a complex and unique design. However, when the design of the optical microstructures is changed or needs to be adjusted, a new mold for the injection process must be designed. This greatly increases fabrication cost and time for product development.

The information disclosed in this “Background OF THE INVENTION” section is only for enhancement of understanding of the background of the described technology and therefore it may contain information that does not form the prior art that is already known to a person of ordinary skill in the art. Further, the information disclosed in the “Background OF THE INVENTION” section does not mean that one or more problems to be resolved by one or more embodiments of the invention was acknowledged by a person of ordinary skill in the art.

### SUMMARY OF THE INVENTION

The invention provides a manufacturing method of a light guide plate, for reducing manufacturing time and cost.

Other objects and advantages of the invention can be further illustrated by the technical features broadly embodied and described as follows.

In order to achieve one or a portion of or all of the objects or other objects, an embodiment of the invention provides a manufacturing method of a light guide plate. A transparent plate is provided. A surface of the transparent plate has a plurality of first optical microstructures. Next a first hot pressing roller having a plurality of transfer printing microstructures is provided. A plurality of second optical microstructures are formed on the surface of the transparent plate through the transfer printing microstructures by the first hot pressing roller. At least a part of the second optical microstructures is not overlapped with the first optical microstructures.

Based on the above, the embodiments of the invention include at least the following advantages or effects. In the manufacturing method of the light guide plate of the invention, under a condition that the transparent plate has first optical microstructures thereon, the transfer printing microstructures on the hot pressing roller are used to form the second optical microstructures on the transparent plate. Through this manufacturing method, the first optical microstructures with complex shapes can be formed on the transparent plate in advance through an injection molding process with a higher and more stable transfer ratio. Then, the second optical microstructures for optimizing optical effects are formed on the transparent plate through hot pressing. Thus, not only the first optical microstructures with complex shapes can be precisely formed through the injection molding process, but also optical and display optimization toward the backlight module can be performed by the second optical microstructures with simple shapes, so as to save production time. Further, the second optical microstructures are formed through hot pressing and not through an injection molding process. Thus, when optical and display optimization towards the backlight module is performed by the second optical microstructures, the time and cost required to remake injection molds is omitted. Only the transfer printing microstructures on the hot pressing roller which has lower cost and fabrication time needs be replaced. This greatly reduces production time and cost.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a flow chart illustrating a manufacturing method of a light guide plate of an embodiment of the invention.

FIG. 2A through FIG. 2D are schematic views illustrating the steps in the manufacturing method of FIG. 1.

FIG. 3 is a schematic view of the light guide plate of FIG. 2D applied to a backlight module.

FIG. 4A and FIG. 4B are schematic views illustrating a manufacturing method of a transparent plate shown in FIG. 2A.

FIG. 5 is a schematic partial view of the transfer printing surface of a first hot pressing roller of FIG. 2B.

FIG. 6 is a schematic partially enlarged view of a reference point of FIG. 5 transfer printed on the transparent plate.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

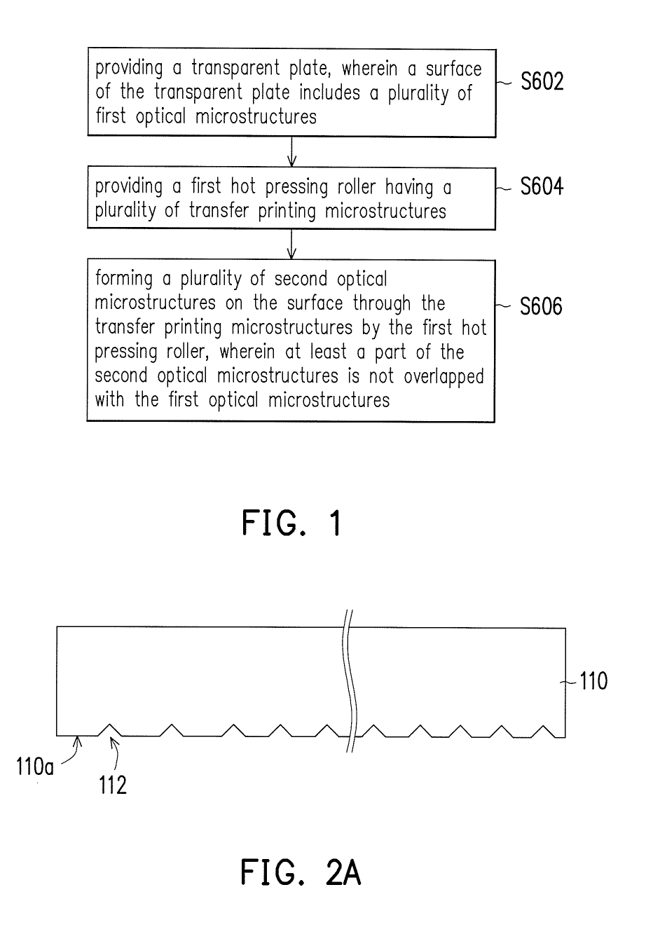

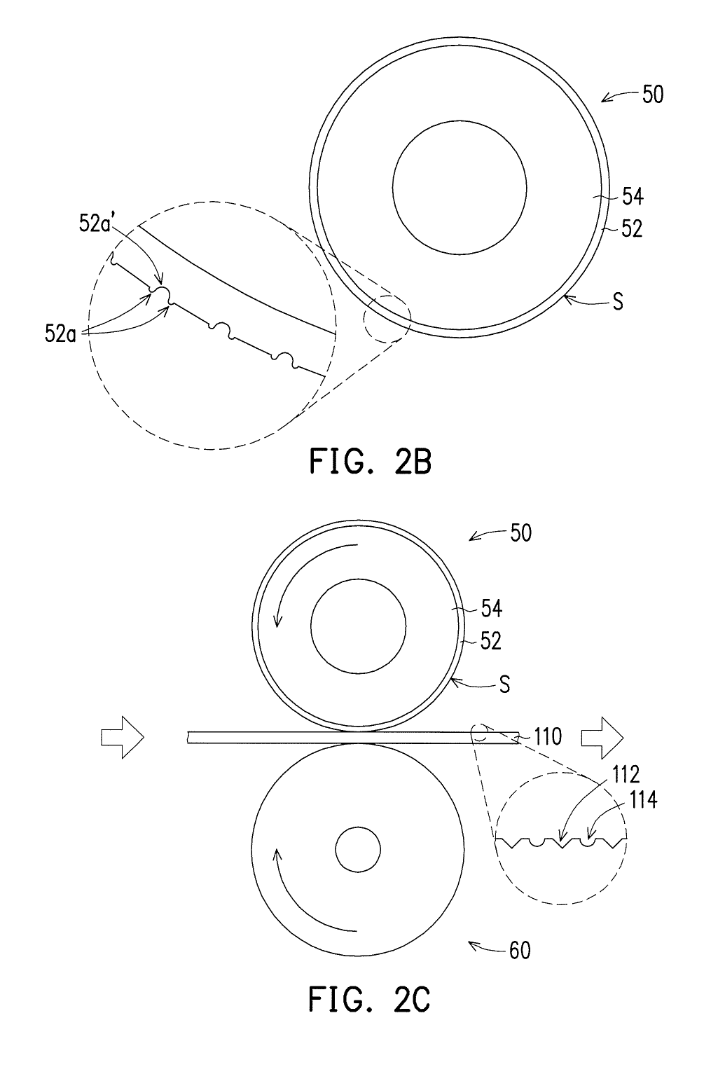

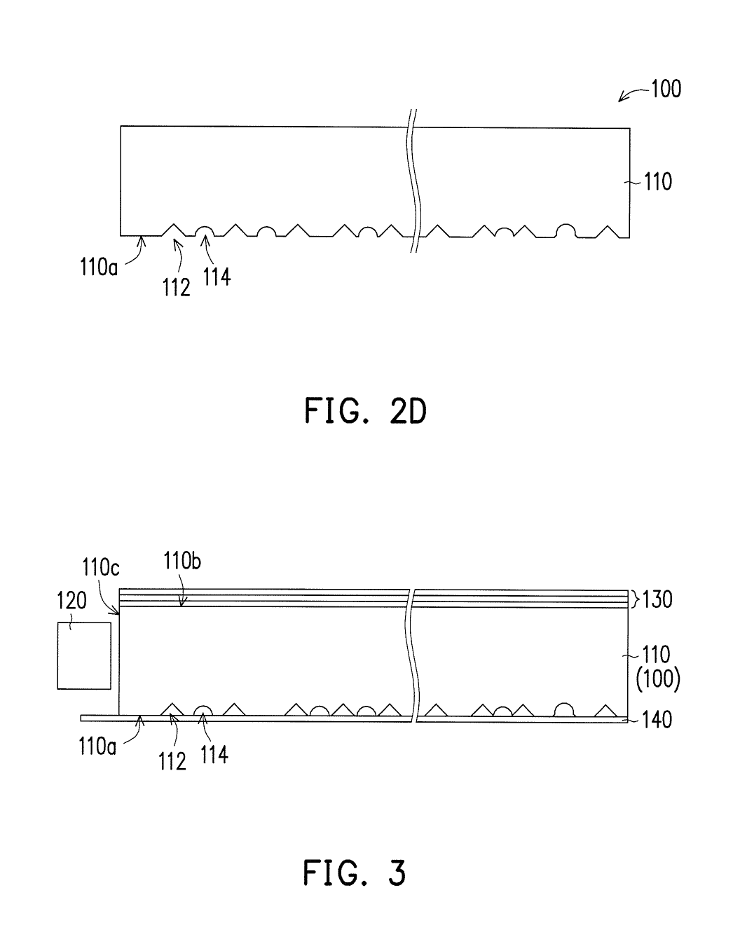

FIG. 1 is a flow chart illustrating a manufacturing method of a light guide plate of an embodiment of the invention. FIG. 2A through FIG. 2D are schematic views illustrating the steps in the manufacturing method of FIG. 1. Referring to FIG. 1, a transparent plate 110 shown in FIG. 2A is provided. The transparent plate 110 includes a surface 110a having a plurality of first optical microstructures 112 (step S602). A thickness of the transparent plate 110 is, for example, from 0.25 mm to 2.0 mm. A material of the transparent plate 110 is, for example, polyethylene terephthalate (PET), polymethyl methacrylate (PMMA), polycarbonate (PC), a compound of PMMA and PC, or other suitable materials. The invention is not limited thereto.

Next, a first hot pressing roller 50 shown in FIG. 2B is provided. A transfer printing surface S of the first hot pressing roller 50 includes a plurality of transfer printing microstructures 52a (step S604). Next, as seen in the first hot pressing roller 50 of FIG. 2C, the transfer printing microstructures 52a of FIG. 2B form a plurality of second optical microstructures 114 on the surface 110a of the transparent plate 110. At least a part of the second optical microstructures 114 is not overlapped with the first optical microstructures 112 (step S606). After the step S606 performing the hot pressing towards the transparent plate 110, a light guide plate 100 including the first optical microstructures 112 and the second optical microstructures 114 is formed as seen in FIG. 2D. FIG. 3 is a schematic view of the light guide plate of FIG. 2D applied to a backlight module. Referring to FIG. 3, after the transparent plate 110 is processed by the aforementioned steps to become the light guide plate 100, a reflector 140 and an optical film set 130 are respectively disposed on the bottom surface (surface 110a) and a light exit surface 110b of the light guide plate 100 (transparent plate 110). A light source 120 is disposed at the light incident surface 110c of the light guide plate 100 (transparent plate 110), so as to form a backlight module suitable to be applied in a display apparatus.

In the embodiment, the transparent plate 110 and the first optical microstructures 112 are, for example, formed by an injection molding process. The shapes of the first optical microstructures 112 are complex and irregular. This allows the light guide plate (transparent plate 110) applied in the backlight module to achieve high luminance. The first optical microstructures 112 shown in FIGS. 2A, 2C, 2D, and 3 are for illustration purposes only. The first optical microstructures 112 can include varying reflective surfaces with different curvatures or other irregularly shaped reflective surfaces. The invention is not limited thereto. The transfer printing microstructures 52a are formed as, for example, protrusion structures surrounding a plurality of concaves 52a′ formed by a laser etching process towards the first hot pressing roller 50. The second optical microstructures 114 are concave structures formed from the corresponding transfer printing microstructures 52a on the transparent plate 110. The shapes of second optical microstructures 114 are simpler, for example, annular or arc-shaped concave. However, the invention is not limited thereto.

In the manufacturing method of the light guide plate of the invention, under a condition that the transparent plate 110 includes the first optical microstructures 112, the transfer printing microstructures 52a on the first hot pressing roller 50 are used to form the second optical microstructures 114 on the transparent plate 110. Through this manufacturing method, optical microstructures with complex shapes (i.e. the first optical microstructures 112) can be formed on the transparent plate 110 in advance through an injection molding process with a higher and more stable transfer ratio. Then, optical microstructures with simple shapes (i.e. the second optical microstructures 114) are formed on the transparent plate 110 through hot pressing. Thus, not only the optical microstructures with complex shapes can be precisely formed through the injection molding process, but also optical and display optimization toward the backlight module can be performed by the optical microstructures with simple shapes, so as to save production time. It should be noted that, in the aforementioned manufacturing method, the first optical microstructures 112 and the second optical microstructures 114 on the transparent plate 110 are mostly separated from each other. However, the invention is not limited thereto. A portion of the transfer printing structures 52a may directly perform transfer printing on the first optical microstructures 112 (i.e. the first optical microstructures 112 and the second microstructures 114 are at least partially overlapped, as seen in the optical microstructures on the right-hand side of the transparent plate 110 in FIG. 2D, FIG. 3). The overlapping optical microstructures provide different optical effects from the first optical microstructures 112 and the second optical microstructures 114.

Specifically, after completing the manufacture of the optical microstructures 112 and the second optical microstructures 114, an optical test may be performed towards the transparent plate 110 to obtain an optical test result. Then it is determined if the transfer printing microstructures 52a are to be fabricated again according to the optical test result so as to perform optical and display optimization. When the optical test result satisfies a predetermined value, the transfer printing microstructures 52a are not fabricated again. When the optical test result does not satisfy a predetermined value, then the transfer printing microstructures 52a are fabricated again. For example, the light source is disposed beside the light incident surface of the transparent plate 110, and the optical test result is a tested luminance or uniformity through the light exit surface of the transparent plate 110. The predetermined value is, for example, a luminance or uniformity value. However, the invention is not limited thereto. The second optical microstructures 114 of the embodiment are formed through hot pressing and not through an injection molding process. Thus, when optical and display optimization towards the backlight module is performed by the second optical microstructures 114, the time and cost required to remake injection molds is omitted. Only the transfer printing microstructures 52a on the first hot pressing roller 50 which has lower cost and fabrication time needs be replaced. This greatly reduces production time and cost.

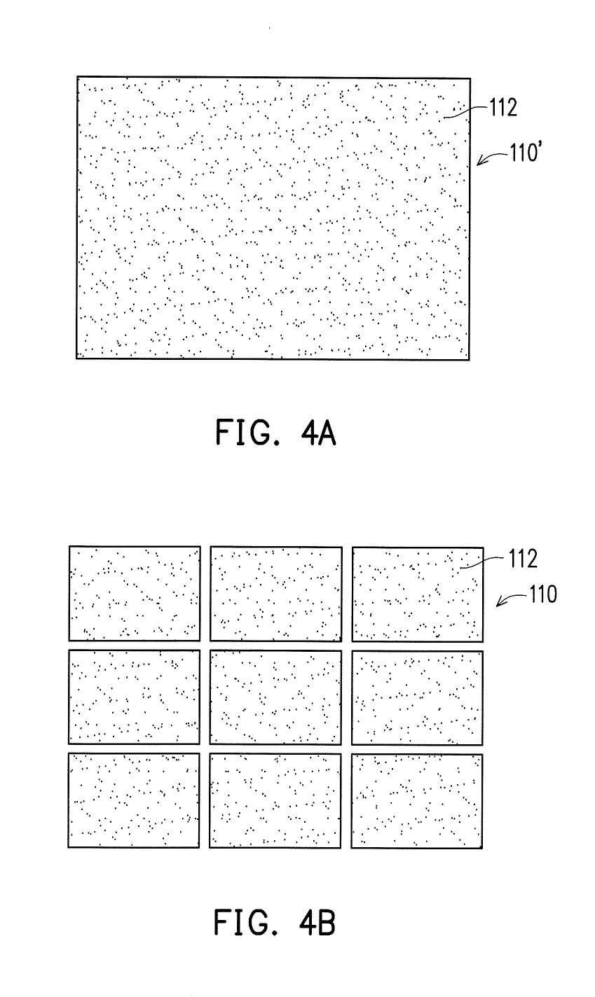

FIG. 4A and FIG. 4B are schematic views illustrating a manufacturing method of the transparent plate shown in FIG. 2A. In the embodiment, as seen in FIG. 4A, the transparent base 110′ with large dimensions and the first optical microstructures 112 are first formed through, for example an injection molding process. Then, as seen in FIG. 4B, the transparent base 110′ is cut to form multiple transparent plates 110 of FIG. 2A. Accordingly, the injection mold for forming the transparent plate 110 is able to be commonly used. That is to say, the transparent plate 110 does not require different injection molds for different dimensions.

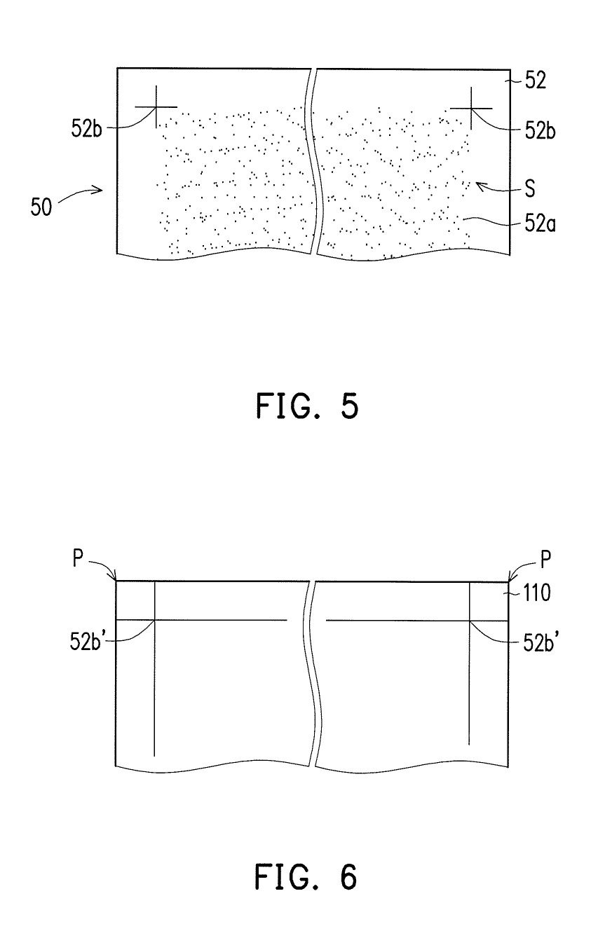

FIG. 5 is a schematic partial view of the transfer printing surface of the first hot pressing roller of FIG. 2B. FIG. 6 is a schematic partially enlarged view of a reference point of FIG. 5 transfer printed on the transparent plate. Referring to FIG. 5 and FIG. 6, in the embodiment, a transfer printing surface S of the first hot pressing roller 50 includes not only the transfer printing microstructures 52a, but also includes a plurality of reference points 52b (FIG. 5 schematically shows two). The first hot pressing roller 50 and the transparent plate 110 are aligned according to the reference points 52b. For example, while the second optical microstructures 114 are formed on the transparent plate 110 through the transfer printing microstructures 52a, at the same time the reference points 52b are transfer printed onto the transparent plate 110 to form the alignment reference points 52b′ of FIG. 6. When the alignment reference points 52b as seen in FIG. 6 are transferred near a top point P (or corner point) of the transparent plate 110, it can be confirmed during the transfer printing process that the first hot pressing roller 50 and the transparent plate 110 are aligned correctly. This way, the required transfer printing microstructures 52a are correctly transferred onto the transparent plate 110.

In the embodiment, for example, the following method provides the first hot pressing roller 50 of FIG. 2B. A flexible transfer printing plate 52 and a roller body 54 are provided. The roller body 54 is, for example, provided with heating equipment and pressurizing equipment. The transfer printing microstructures 52a and the reference points 52b (shown in FIG. 5) are formed on the transfer printing surface S of the flexible transfer printing plate 52 through a laser etching process. Next, the flexible transfer printing plate 52 is assembled on the roller body 54 to complete the first hot pressing roller 50 of FIG. 2B.

In the embodiment, when hot pressing is performed towards the transparent plate 110, a second hot pressing roller 60 as shown in FIG. 2C may be provided. The transparent plate 110 may pass between the first hot pressing roller 50 and the second hot pressing roller 60. The first hot pressing roller 50 and the second hot pressing roller 60 is provided with, for example, heating equipment and pressurizing equipment. The transparent plate 110 is heated and pressurized through the first hot pressing roller 50 and the second hot pressing roller 60.

To sum up, the embodiments of the invention include at least the following advantages or effects. In the manufacturing method of the light guide plate of the invention, under a condition that the transparent plate has first optical microstructures thereon, the transfer printing microstructures on the hot pressing roller are used to form the second optical microstructures on the transparent plate. Through this manufacturing method, the first optical microstructures with complex shapes can be formed on the transparent plate in advance through an injection molding process with a higher and more stable transfer ratio. Then, the second optical microstructures for optimizing optical effects are formed on the transparent plate through hot pressing. Thus, not only the first optical microstructures with complex shapes can be precisely formed through the injection molding process, but also optical and display optimization toward the backlight module can be performed by the second optical microstructures with simple shapes, so as to save production time. Further, the second optical microstructures are formed through hot pressing and not through an injection molding process. Thus, when optical and display optimization towards the backlight module is performed by the second optical microstructures, the time and cost required to remake injection molds is omitted. Only the transfer printing microstructures on the hot pressing roller which has lower cost and fabrication time needs be replaced. This greatly reduces production time and cost.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A manufacturing method of a light guide plate, comprising:
providing a transparent plate, wherein a surface of the transparent plate comprises a plurality of first optical microstructures;
providing a first hot pressing roller having a plurality of transfer printing microstructures; and
forming a plurality of second optical microstructures on the surface through the transfer printing microstructures by the first hot pressing roller, wherein at least a part of the second optical microstructures is not overlapped with the first optical microstructures.

2. The manufacturing method of the light guide plate as claimed in claim 1, wherein the step of providing the transparent plate comprises:
forming the transparent plate and the first optical microstructures through an injection molding process.

3. The manufacturing method of the light guide plate as claimed in claim 2, wherein the step of forming the transparent plate through the injection molding process comprises:
forming a transparent base and the first optical microstructures through the injection molding process; and
cutting the transparent base to form the transparent plate.

4. The manufacturing method of the light guide plate as claimed in claim 1, wherein the step of providing the first hot pressing roller comprises:
forming the transfer printing microstructures through a laser etching process.

5. The manufacturing method of the light guide plate as claimed in claim 1, wherein the step of providing the first hot pressing roller comprises:
providing a roller body and a flexible transfer printing plate, wherein the transfer printing microstructures are formed on the flexible transfer printing plate; and
assembling the flexible transfer printing plate on the roller body.

6. The manufacturing method of the light guide plate as claimed in claim 1, wherein the first hot pressing roller comprises a plurality of reference points, and the step of forming the second optical microstructures on the surface through the transfer printing microstructures comprises:
aligning the first hot pressing roller and the transparent plate according to the reference points.

7. The manufacturing method of the light guide plate as claimed in claim 6, wherein the step of providing the first hot pressing roller comprises:
forming the reference points through a laser etching process.

8. The manufacturing method of the light guide plate as claimed in claim 6, wherein the step of providing the first hot pressing roller comprises:
providing a roller body and a flexible transfer printing plate, wherein the transfer printing microstructures and the reference points are formed on the flexible transfer printing plate; and
assembling the flexible transfer printing plate on the roller body.

9. The manufacturing method of the light guide plate as claimed in claim 1, further comprising:
performing an optical test towards the transparent plate to obtain an optical test result; and
fabricating the transfer printing microstructures again according to the optical test result.

10. The manufacturing method of the light guide plate as claimed in claim 1, wherein the step of forming the second optical microstructures on the surface through the transfer printing microstructures comprises:
providing a second hot pressing roller; and
passing the transparent plate between the first hot pressing roller and the second hot pressing roller, wherein the transparent plate is heated and pressurized through the first hot pressing roller and the second hot pressing roller.
